(19) United States
(12) Patent Application Publication
(10) Pub. No.: US 2023/0411979 A1
(43) Pub. Date: Dec. 21, 2023

(54) POWER SUPPLY SYSTEMS

(71) Applicant: Ace Power and Technology Co., Ltd, Shanghai (CN)

(72) Inventor: Yuetian WANG, Shanghai (CN)

(73) Assignee: Ace Power and Technology Co., Ltd, Shanghai (CN)

(21) Appl. No.: 18/210,143

(22) Filed: Jun. 15, 2023

(30) Foreign Application Priority Data
Jun. 17, 2022 (CN) 202221531332.9

(51) Int. Cl. H02J 7/00; H02J 7/35

(52) U.S. Cl. CPC H02J 7/0068; H02J 7/35; H02J 2207/20

(57) ABSTRACT

A power supply system includes: a first direct current (DC) input terminal for providing first initial DC power; a second DC input terminal for providing second initial DC power; a transfer switch unit coupled to the first DC input terminal and the second DC input terminal, wherein the transfer switch unit is configured to select the first initial DC power or the second initial DC power as third initial DC power input to the power supply system; and conversion circuitry coupled to the transfer switch unit, wherein the conversion circuitry is configured to convert the third initial DC power into a target power supply for a load device.

### CROSS-REFERENCE TO RELATED APPLICATION

This application claims the benefit of priority of Chinese Patent Application No. 202221531332.9, filed on Jun. 17, 2022, the disclosure of which is incorporated herein by reference in its entirety.

### TECHNICAL FIELD

The present application relates to power supply technologies, and in particular, to power supply systems.

### BACKGROUND

A power supplying mode as shown in FIG. 1 is generally used in a refrigeration air conditioner and a fan for a current data center. In this power supply mode, there are generally two input channels, that is, a channel A and a channel B. When a fault occurs in one of the two input channels, it is automatically switched to the other of the two input channels by an automatic transfer switch equipment (ATS) connected to it. To ensure the continuity of subsequent power supplying, the power supplying will be suspended for several milliseconds during switching. There are several problems with the power supply system: 1. the ATS is required, and the power supplying will be suspended for several milliseconds during switching; 2. generally, an alternating current (AC) uninterruptible power system (UPS) is used for one of the two input channels, and thus, an additional AC UPS is needed.

### SUMMARY

In view of the above, an embodiment of the present application provides a power supply system including:
a first direct current (DC) input terminal for providing first initial DC power;
a second DC input terminal for providing second initial DC power;
a transfer switch unit coupled to the first DC input terminal and the second DC input terminal, wherein the transfer switch unit is configured to select the first initial DC power or the second initial DC power as third initial DC power input to the power supply system; and
conversion circuitry coupled to the transfer switch unit, wherein the conversion circuitry is configured to convert the third initial DC power into a target power supply for a load device.

An embodiment of the present application further provides a power supply device applied to a power supply system including:
a first direct current (DC) input terminal for providing first initial DC power;
a second DC input terminal for providing second initial DC power;
a transfer switch unit coupled to the first DC input terminal and the second DC input terminal, wherein the transfer switch unit is configured to select the first initial DC power or the second initial DC power as third initial DC power input to the power supply system; and
conversion circuitry coupled to the transfer switch unit, wherein the conversion circuitry is configured to convert the third initial DC power into a target power supply for a load device.

### BRIEF DESCRIPTION OF THE DRAWINGS

FIG. 1 is a block diagram of a power supply system in the related art.

FIG. 2 is a schematic block diagram of a power supply system according to an embodiment of the present application.

FIG. 3 is a schematic block diagram of a power supply system according to an embodiment of the present application.

FIG. 4 is a schematic block diagram of a power supply system according to an embodiment of the present application.

FIG. 5 is a schematic block diagram of a power supply system according to an embodiment of the present application.

### DETAILED DESCRIPTION

Some embodiments of the present application will be described in detail below in conjunction with the drawings. The embodiments are provided for illustrative purposes only, not intended to limit the scope of the present application.

In addition, the term “first”, “second” are for illustrative purposes only and are not to be construed as indicating or imposing relative importance or implicitly indicating the number of technical features indicated. Thus, a feature limited by “first”, “second”, or the like may expressly or implicitly include one or more of the features. In the description of the present application, the meaning of “plural/plurality” is two or more, unless otherwise specifically defined.

In the present application, the term “exemplary” is used to mean “as an example, illustration, or illustration.” Any embodiment described herein as “exemplary” is not necessarily to be construed as preferred or advantageous over other embodiments. To enable any person skilled in the art to make and use the present application, the following description is given. In the following description, details are set forth for purposes of explanation. It will be appreciated by those of ordinary skill in the art that the present application may be practiced without these specific details. In other examples, well-known structures and procedures will not be set forth in detail so as not to obscure the description of the present application with unnecessary detail. Thus, the present application is not intended to be limited to the shown embodiments, but is to be accorded the broadest scope consistent with the principles and features disclosed herein.

An embodiment of the present application provides a power supply system and a power supply device, which are described in detail below.

FIG. 2 is a schematic block diagram of a power supply system according to an embodiment of the present application. The power supply system includes a first direct current (DC) terminal 101 for providing first initial DC power and a second DC input terminal 102 for providing second initial DC power. In the application of the power supply system, each of the first DC input terminal 101 and the second DC input terminal 102 is input with DC power. The power supply system is configured to supply power to the load device 200 shown in FIG. 2. The load device 200 may be any device, such as a compressor of an air conditioner or a fan, which is not specifically limited herein.

The power supply system in the embodiment further includes:
the transfer switch unit 300 coupled to the first DC input terminal 101 and the second DC input terminal 102 and configured to select the first initial DC power or the second initial DC power as initial DC power input to the power supply system. In the present embodiment, the transfer switch unit 300 uses a dual-power automatic transfer switch equipment (ATS). Through the ATS, the first DC input terminal 101 and the second DC input terminal 102 are automatically switched for supplying power.

In the operation process, when the first DC input terminal 101 and the second DC input terminal 102 are not faulty, the transfer switch unit 300 selects any of the first DC input terminal 101 and the second DC input terminal 102 to supply the initial DC power to the power supply system. When a power supplying fault occurs at the first DC input terminal 101, the transfer switch unit 300 selects the second initial DC power input from the second DC input terminal 102 as the initial DC power input to the power supply system. When the power supplying fault occurs at the second DC input terminal 102, the transfer switch unit 300 selects the first initial DC power input from the first DC input terminal 101 as initial DC power input to the power supply system.

The power supply system further includes conversion circuitry 400 coupled to the transfer switch unit 300 and configured to convert the initial DC power into a target power supply for a load device 200.

In an embodiment of the present application, the first DC input terminal 101 or the second DC input terminal 102 is used to provide the initial DC power to the power supply system, and the initial DC power is converted by the conversion circuitry 400 into the target power supply for the load device 200. In an application process, when the power supplying fault occurs in any one of the first DC input terminal 101 and the second DC input terminal 102, the other of the first DC input terminal 101 and the second DC input terminal 102 is selected by the transfer switch unit 300 to continue to input the initial DC power to a rear end of the power supply system, thereby ensuring a steady supply of power. Since both the first DC input terminal 101 and the second DC input terminal 102 provide DC powers, the probability of suspension of the power supplying during a switching process is reduced, smooth switching between power supplying modes is realized, and an additional AC UPS system is not required in the present application, thereby reducing usage cost.

In an embodiment of the present embodiment, the conversion circuitry 400 includes a frequency conversion circuit 401 coupled to the transfer switch unit 300 and configured to perform frequency conversion processing on the initial DC power to obtain the target power supply. The frequency conversion circuit 401 includes an inverter that converts the input initial DC power into the target power supply of a set frequency and voltage, and the target power supply includes an alternating current to supply power to the load device 200. The frequency and voltage of the target power supply are adjusted according to the load device 200 in the power supply system.

The conversion circuitry 400 further includes a DC-DC conversion circuit 402 between and coupled between the transfer switch unit 300 and the frequency conversion circuit 401 for converting the initial DC power into DC power matching an input terminal of the frequency conversion circuit 401. The DC-DC conversion circuit 402 and the frequency conversion circuit 401 are coupled through two DC buses. A bus capacitor C1 is between and coupled to the DC-DC conversion circuit 402 and the frequency conversion circuit 401. The bus capacitor C1 may store energy so that the variable frequency sub-unit 401 is used as a voltage source. In an embodiment of the present application, the bus capacitor C1 may further be disposed in the variable frequency sub-unit 401.

In another embodiment of the present application, the power supply system further includes a power source unit 600. The first DC input terminal 101 and/or the second DC input terminal 102 are coupled to the power source unit 600. The power source unit 600 supplies the DC power to the first DC input terminal 101 and/or the second DC input terminal 102.

The power source unit 600 may provide the initial DC power to the first DC input terminal 101 and/or the second DC input terminal 102 in power supplying modes of the storage battery 601 and the solar converter 602, or may provide the initial DC power to the first DC input terminal 101 and/or the second DC input terminal 102 in an AC-DC mean.

In an embodiment of the present application, the modes for providing the initial DC power include but are not limited to the above two modes, and other modes for providing the initial DC power also fall within the scope of the present application.

The two modes of providing the initial DC power are set forth below.

In another embodiment of the present application, as shown in FIG. 3, the power source unit 600 includes a storage battery 601 and a solar converter 602. The first DC input terminal 101 and/or the second DC input terminal 102 are coupled to the storage battery 601. The storage battery 601 is coupled to the solar converter 602. In the present embodiment, the solar converter 602 is coupled to an external solar energy device. The external solar energy device converts light energy into electric energy, and charges the storage battery 601 with the electric energy by the solar converter 602. The storage battery 601 may provide initial DC power for the first DC input terminal 101 and/or the second DC input terminal 102.

Specifically, the above solution includes the following cases: 1. as shown in FIG. 3, both the first DC input terminal 101 and the second DC input terminal 102 are coupled to the storage battery 601; 2. the first DC input terminal 101 is coupled to the storage battery 601, and the second DC input terminal 102 is not coupled to the storage battery 601; and 3. the first DC input terminal 101 is not coupled to the storage battery 601, and the second DC input terminal 102 is coupled to the storage battery 601. The second and third cases may be derived from FIG. 3. Therefore, the drawings of the description of the present application do not depict the second and third cases.

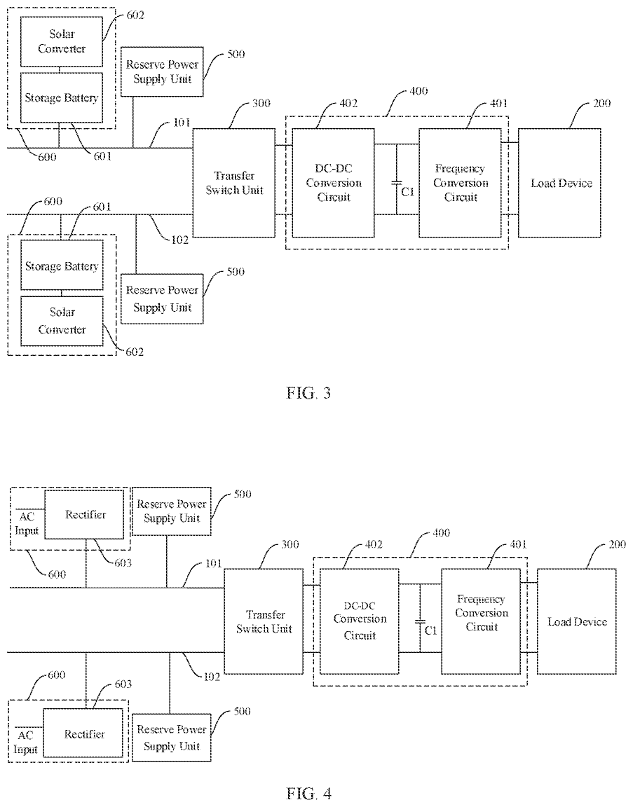

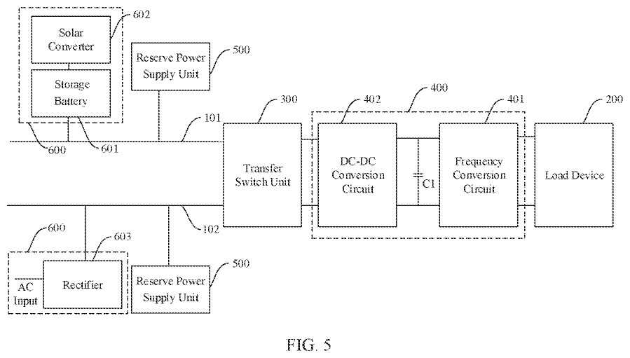

In another embodiment of the present application, as shown in FIG. 4, the power source unit 600 includes a rectifier 603. The first DC input terminal 101 and/or the second DC input terminal 102 are coupled to the rectifier 603. The rectifier 603 converts AC power input from an AC power supply to the initial DC power and provides the initial DC power to the first DC input terminal 101 and/or the second DC input terminal 102. The AC power supply may be a mains supply.

Specifically, the above solution includes the following cases: 1. as shown in FIG. 4, both the first DC input terminal 101 and the second DC input terminal 102 are coupled to the rectifier 603; 2. the first DC input terminal 101 is coupled to the rectifier 603, and the second DC input terminal 102 is not coupled to the rectifier 603; and 3. the first DC input terminal 101 is not coupled to the rectifier 603, and the second DC input terminal 102 is coupled to the rectifier 603. The second and third cases may be derived from FIG. 3. Therefore, the drawings of the description of the present application do not depict the second and third cases.

In another embodiment of the present application, as shown in FIG. 5, the power source unit 600 includes a solar converter 602, a storage battery 601, and a rectifier sub-unit 603. Specifically, one of the first DC input terminal 101 and the second DC input terminal 102 is coupled to the storage battery 601, the storage battery 601 is coupled to the solar converter 602, the other of the first DC input terminal 101 and the second DC input terminal 102 is coupled to the rectifier 603, and the rectifier 603 is coupled to the AC power supply.

In an embodiment of the present application, the power supply system further includes a reserve power supply unit 500. The first DC input terminal 101 and/or the second DC input terminal 102 are coupled to the reserve power supply unit 500. The reserve power supply unit 500 supplies reserve DC power to the load device 200 when the first DC input terminal 101 and/or the second DC input terminal 102 are powered down.

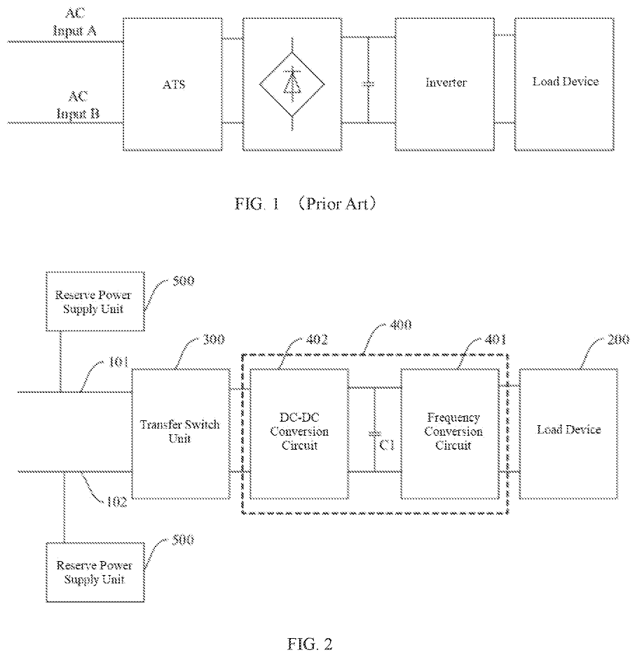

Specifically, the above solution includes the following cases: 1. as shown in FIG. 1, both the first DC input terminal 101 and the second DC input terminal 102 are coupled to the reserve power supply unit 500; 2. the first DC input terminal 101 is coupled to the reserve power supply unit 500, and the second DC input terminal 102 is not coupled to the reserve power supply unit 500; and 3. the first DC input terminal 101 is not coupled to the reserve power supply unit 500, and the second DC input terminal 102 is coupled to the reserve power supply unit 500. The second and third cases may be derived from FIG. 3. Therefore, the drawings of the description of the present application do not depict the second and third cases.

Exemplary, when the first DC input terminal 101 is coupled to the reserve power supply unit 500, the reserve power supply unit 500 is directly coupled to the DC bus of the first DC input terminal 101. When the second DC input terminal 102 is coupled to the reserve power supply unit 500, the reserve power supply unit 500 is directly coupled to the DC bus of the second DC input terminal 102. During the switching is performed between the first DC input terminal 101 and the second DC input terminal 102 or the initial DC power is off, the reserve DC power is supplied by the reserve power supply unit 500 to the load device 200.

In another embodiment of the present application, the DC-DC conversion circuit 402 includes an isolated DC-DC conversion circuit or a non-isolated DC-DC conversion circuit. Specifically, when the DC-DC conversion circuit 402 includes the isolated DC-DC conversion circuit, the isolated DC-DC conversion circuit may be such as a buck-type topology conversion unit, a boost-type topology conversion unit, a buck-boost-type topology conversion unit, or the like. When the DC-DC conversion circuit 402 includes the non-isolated DC-DC conversion circuit, the non-isolated DC-DC conversion circuit may be a forward topology conversion unit, a flyback topology conversion unit, a push-pull topology conversion unit, a half-bridge topology conversion unit, a full-bridge topology conversion unit, or the like. In this embodiment, the topology for the DC-DC conversion circuit 402 is not limited.

In another embodiment of the present application, a power supply device is provided. The power supply device is applied to the power supply system as described above. In an embodiment, as shown in FIG. 2, the power supply device includes a first DC input terminal 101 for providing first initial DC power, and a second DC input terminal 102 for providing second initial DC power. In the application of the power supply system, each of the first DC input terminal 101 and the second DC input terminal 102 is input with DC power. The power supply device is configured to supply power to the load device 200 shown in FIG. 2. The load device 200 may be any device, such as a compressor of an air conditioner or a fan, which is not specifically limited herein.

The power supply device in an embodiment further includes:
the transfer switch unit 300 coupled to the first DC input terminal 101 and the second DC input terminal 102 and configured to select the first initial DC power or the second initial DC power as initial DC power input to the power supply system. In the present embodiment, the transfer switch unit 300 uses a dual-power automatic transfer switch equipment (ATS). Through the ATS, the first DC input terminal 101 and the second DC input terminal 102 are automatically switched for supplying power.

In the operation process, when the first DC input terminal 101 and the second DC input terminal 102 are not faulty, the transfer switch unit 300 selects any of the first DC input terminal 101 and the second DC input terminal 102 to supply the initial DC power to the power supply system. When the power supplying fault occurs at the first DC input terminal 101, the transfer switch unit 300 selects the second initial DC power input from the second DC input terminal 102 as the initial DC power input to the power supply system. When the power supplying fault occurs at the second DC input terminal 102, the transfer switch unit 300 selects the first initial DC power input from the first DC input terminal 101 as initial DC power input to the power supply system.

The power supply system further includes conversion circuitry 400 coupled to the transfer switch unit 300 and configured to convert the initial DC power into a target power supply for the load device 200.

In an embodiment of the present application, the first DC input terminal 101 or the second DC input terminal 102 may provide the initial DC power to the power supply device, and the initial DC power is converted by the conversion circuitry 400 into the target power supply for the load device 200. In an application process, when the power supplying fault occurs in any one of the first DC input terminal 101 and the second DC input terminal 102, the other of the first DC input terminal 101 and the second DC input terminal 102 is selected by the transfer switch unit 300 to input the initial DC power to a rear end of the power supply system, thereby ensuring a steady supply of power. Since both the first DC input terminal 101 and the second DC input terminal 102 provide DC powers, the probability of the suspension of the power supplying during a switching process is reduced, the smooth switching between the power supplying modes is realized, and an additional AC UPS system is not required in the present application, thereby reducing usage cost.

In an embodiment of the present embodiment, the conversion circuitry 400 includes a frequency conversion circuit 401 coupled to the transfer switch unit 300 and configured to perform frequency conversion processing on the initial DC power to obtain the target power supply. The frequency conversion circuit 401 includes an inverter that converts the input initial DC power into the target power supply of a set frequency and voltage, and the target power supply includes an alternating current to supply power to the load device 200. The frequency and voltage of the target power supply are adjusted according to the load device 200 in the power supply device.

The conversion circuitry 400 further includes a DC-DC conversion circuit 402 between and coupled to the transfer switch unit 300 and the frequency conversion circuit 401 for converting the initial DC power into DC power matching an input terminal of the frequency conversion circuit 401. The DC-DC conversion circuit 402 and the frequency conversion circuit 401 are coupled through two DC buses. A bus capacitor C1 is between and coupled to the DC-DC conversion circuit 402 and the frequency conversion circuit 401. The bus capacitor C1 may store energy so that the variable frequency sub-unit 401 is used as a voltage source. In an embodiment of the present application, the bus capacitor C1 may further be disposed in the variable frequency sub-unit 401.

In another embodiment of the present application, the power supply device further includes a power source unit 600. The first DC input terminal 101 and/or the second DC input terminal 102 are coupled to the power source unit 600. The power source unit 600 supplies the DC power to the first DC input terminal 101 and/or the second DC input terminal 102.

The power source unit 600 may provide the initial DC power to the first DC input terminal 101 and/or the second DC input terminal 102 in power supplying modes of the storage battery 601 and the solar converter 602, or may provide the initial DC power to the first DC input terminal 101 and/or the second DC input terminal 102 in an AC-DC mean.

In an embodiment of the present application, the modes for providing the initial DC power include but are not limited to the above two modes, and other modes for providing the initial DC power also fall within the scope of the present application.

The two modes of providing the initial DC power are set forth below.

In another embodiment of the present application, as shown in FIG. 3, the power source unit 600 includes a solar converter 602 and a storage battery 601. The first DC input terminal 101 and/or the second DC input terminal 102 are coupled to the storage battery 601. The storage battery 601 is coupled to the solar converter 602. In an embodiment, the solar converter 602 is coupled to an external solar energy device. The external solar energy device converts light energy into electric energy, and charges the storage battery 601 with the electric energy by the solar converter 602. The storage battery 601 may provide initial DC power for the first DC input terminal 101 and/or the second DC input terminal 102.

Specifically, the above solution includes the following cases: 1. as shown in FIG. 3, both the first DC input terminal 101 and the second DC input terminal 102 are coupled to the storage battery 601; 2. the first DC input terminal 101 is coupled to the storage battery 601, and the second DC input terminal 102 is not coupled to the storage battery 601; and 3. the first DC input terminal 101 is not coupled to the storage battery 601, and the second DC input terminal 102 is coupled to the storage battery 601. The second and third cases may be derived from FIG. 3. Therefore, the drawings of the description of the present application do not depict the second and third cases.

In another embodiment of the present application, as shown in FIG. 4, the power source unit 600 includes a rectifier 603. The first DC input terminal 101 and/or the second DC input terminal 102 are coupled to the rectifier 603. The rectifier 603 converts AC power input from an AC power supply to the initial DC power and provides the initial DC power to the first DC input terminal 101 and/or the second DC input terminal 102. The AC power supply may be a mains supply.

Specifically, the above solution includes the following cases: 1. as shown in FIG. 4, both the first DC input terminal 101 and the second DC input terminal 102 are coupled to the rectifier 603; 2. the first DC input terminal 101 is coupled to the rectifier 603, and the second DC input terminal 102 is not coupled to the rectifier 603; and 3. the first DC input terminal 101 is not coupled to the rectifier 603, and the second DC input terminal 102 is coupled to the rectifier 603. The second and third cases may be derived from FIG. 4. Therefore, the drawings of the description of the present application do not depict the second and third cases.

In another embodiment of the present application, as shown in FIG. 5, the power source unit 600 includes a solar converter 602, a storage battery 601, and a rectifier sub-unit 603. Specifically, one of the first DC input terminal 101 and the second DC input terminal 102 is coupled to the storage battery 601, the storage battery 601 is coupled to the solar converter 602, the other of the first DC input terminal 101 and the second DC input terminal 102 is coupled to the rectifier 603, and the rectifier 603 is coupled to the AC power supply.

In an embodiment of the present application, the power supply device further includes a reserve power supply unit 500. The first DC input terminal 101 and/or the second DC input terminal 102 are coupled to the reserve power supply unit 500. The reserve power supply unit 500 supplies reserve DC power to the load device 200 when the first DC input terminal 101 and/or the second DC input terminal 102 are powered down.

Specifically, the above solution includes the following cases: 1. as shown in FIG. 1, both the first DC input terminal 101 and the second DC input terminal 102 are coupled to the reserve power supply unit 500; 2. the first DC input terminal 101 is coupled to the reserve power supply unit 500, and the second DC input terminal 102 is not coupled to the reserve power supply unit 500; and 3. the first DC input terminal 101 is not coupled to the reserve power supply unit 500, and the second DC input terminal 102 is coupled to the reserve power supply unit 500. The second and third cases may be derived from FIG. 3. Therefore, the drawings of the description of the present application do not depict the second and third cases.

Exemplary, when the first DC input terminal 101 is coupled to the reserve power supply unit 500, the reserve power supply unit 500 is directly coupled to the DC bus of the first DC input terminal 101. When the second DC input terminal 102 is coupled to the reserve power supply unit 500, the reserve power supply unit 500 is directly coupled to the DC bus of the second DC input terminal 102. During the switching is performed between the first DC input terminal 101 and the second DC input terminal 102 are switched or the initial DC power is off, the reserve DC power is supplied by the reserve power supply unit 500 to the load device 200.

In another embodiment of the present application, the DC-DC conversion circuit 402 includes an isolated DC-DC conversion circuit or a non-isolated DC-DC conversion circuit. Specifically, when the DC-DC conversion circuit 402 includes the isolated DC-DC conversion circuit, the isolated DC-DC conversion circuit may be such as a buck-type topology conversion unit, a boost-type topology conversion unit, a buck-boost-type topology conversion unit, or the like. When the DC-DC conversion circuit 402 includes the non-isolated DC-DC conversion circuit, the non-isolated DC-DC conversion circuit may be a forward topology conversion unit, a flyback topology conversion unit, a push-pull topology conversion unit, a half-bridge topology conversion unit, a full-bridge topology conversion unit, or the like. In this embodiment, the topology for the DC-DC conversion circuit 402 is not limited.

The principles and implementations of the present application are described above by some embodiments. The description of the embodiments is merely provided to help understand the present application. Variations will occur to those skilled in the art based on the teachings of the present application. Thus, the presented description should not be construed as limiting the present application.

What is claimed is:

1. A power supply system comprising:
a first direct current (DC) input terminal for providing first initial DC power;
a second DC input terminal for providing second initial DC power;
a transfer switch unit coupled to the first DC input terminal and the second DC input terminal to select the first initial DC power or the second initial DC power as third initial DC power; and
conversion circuitry coupled to the transfer switch unit to convert the third initial DC power into a target power supply for a load device.

2. The power supply system of claim 1, further comprising a power source unit coupled to at least one of the first DC input terminal or the second DC input terminal to supply DC power to the at least one of the first DC input terminal or the second DC input terminal.

3. The power supply system of claim 2, further comprising a reserve power supply unit coupled to the at least one of the first DC input terminal or the second DC input terminal to supply power to the at least one of the first DC input terminal or the second DC input terminal when the power source unit is powered down.

4. The power supply system of claim 2, wherein the power source unit comprises:
a solar converter; and
a storage battery coupled to the solar converter and the at least one of the first DC input terminal or the second DC input terminal to supply the DC power to the at least one of the first DC input terminal or the second DC input terminal.

5. The power supply system of claim 3, wherein the power source unit comprises:
a solar converter; and
a storage battery coupled to the solar converter and the at least one of the first DC input terminal or the second DC input terminal to supply the DC power to the at least one of the first DC input terminal or the second DC input terminal.

6. The power supply system of claim 2, wherein the power source unit comprises a rectifier for converting input alternating current (AC) power into the DC power for supplying to the at least one of the first DC input terminal or the second DC input terminal.

7. The power supply system of claim 3, wherein the power source unit comprises a rectifier for converting input alternating current (AC) power into the DC power for supplying to the at least one of the first DC input terminal or the second DC input terminal.

8. The power supply system of claim 1, wherein the conversion circuitry comprises a frequency conversion circuit coupled between the transfer switch unit and the load device to perform frequency conversion processing on the third initial DC power to obtain the target power supply.

9. The power supply system of claim 8, wherein the frequency conversion circuit comprises an inverter.

10. The power supply system of claim 8, wherein the conversion circuitry further comprises a DC-DC conversion circuit coupled between the transfer switch unit and the frequency conversion circuit to convert the third initial DC power into DC power matching an input terminal of the frequency conversion circuit.

11. The power supply system of claim 10, wherein the DC-DC conversion circuit is coupled to the frequency conversion circuit through two DC buses, and a bus capacitor is coupled between the two DC buses.

12. The power supply system of claim 11, wherein the DC-DC conversion circuit comprises one of an isolated DC-DC conversion circuit and a non-isolated DC-DC conversion circuit.
